(19) United States
(12) Patent Application Publication
(10) Pub. No.: US 2005/0268249 A1
(43) Pub. Date: Dec. 1, 2005

(54) System and method for multiple document interface

(76) Inventor: Paulo Colaco-Dias, London (GB)

Correspondence Address: RICHARD F. JAWORSKI;Cooper & Dunham LLP, 1185 Avenue of the Americas, New York, NY, 10036, US

(21) Appl. No.: 11/132,733

(22) Filed: May 19, 2005

Related U.S. Application Data
(60) Provisional application No. 60/573,676, filed on May 21, 2004.

(51) Int. Cl. G06F 3/00

(52) U.S. Cl. 715/793; 715/810

(57) ABSTRACT

A method for displaying a MDI graphical user interface, includes displaying a parent window displaying one or more command menus, corresponding to one or more parent window features, within the parent window, displaying one status bar, corresponding to one or more parent window features, within the parent window, displaying, one or more child windows, displaying one or more command menus, corresponding to one or more child window features, within each of the one or more child windows and displaying one status bar, corresponding to one or more child window features, within each of the one or more child windows.

### REFERENCE TO RELATED APPLICATION

The present application is based on provisional application Ser. No. 60/573,676, filed May 21, 2004, the entire contents of which are herein incorporated by reference.

### BACKGROUND

1. Technical Field

The present disclosure relates to document interfaces and, more specifically, to a system and method for multiple document interfaces.

2. Description Of The Related Art

A MDI (Multiple Document Interface) is an application that provides a graphics user interface for other applications and/or documents. MDIs may be used to allow a user to work with multiple documents at the same time. The MDI may display a parent window. The MDI parent window may appear, for example, on the desktop of an operating, system. A MDI uses a single parent window. Where multiple MDIs are running simultaneously on an operating system, multiple MDI parent windows may appear on the desktop. The MDI parent window may have an adjustable appearance. For example, the MDI window may be resized and/or repositioned.

The MDI may be used to display multiple applications and/or documents. Each application and/or document is presented in a separate child window within the MDI parent window. The user can see and work with different documents such as a spreadsheet, a text document, or a drawing space by simply moving the cursor from one space to another.

M D I applications can be used for a variety of purposes. For example, MDI applications can be used for working on one document while referring to another document, simultaneously viewing different presentations of the same information, viewing multiple web sites at the same time, and any task that requires multiple reference points and/or work areas at the same time.

Both the parent window and the child windows may be capable of processing commands. Menus, for example pull-down menus, status bar, and toolbars are displayed only on the parent window. These menus, status bar, and toolbars may facilitate the communication of commands between the user and the windows. When there are no open child windows, the menus, status bar, and toolbars may display menu commands associated with the parent window. When there are one or more child windows open, the menus, status bar, and toolbars of the parent window may display menu commands associated with which ever child window is active.

Where a menu command associated with one window is identical to a menu command associated with another window, it may still be necessary to individually program the actions that result from selecting the various menu commands. This may result in the duplication of lines of code.

### SUMMARY

A method for displaying a MDI graphical user interface, comprises displaying a parent window, displaying one or more command menus, corresponding to one or more parent window features, within the parent window, displaying one status bar, corresponding, to one or more parent window features, within the parent window, displaying one or more child windows, displaying one or more command menus, corresponding to one or more child window features, within each of the one or more child windows and displaying one status bar, corresponding to one or more child window features, within each of the one or more child windows.

A method for designing a MDI graphical user interface, comprises designing a parent window, designing one or more command menus, each comprising one or more menu commands, for the parent window, designing one status bar for the parent window, designing one or more child windows within the parent window, designing one or more command menus, each comprising one or more menu commands, for each of the one or more child windows within the one or more child windows, designing one status bar for each of the one or more child windows within the one or more child windows, assigning each of the one or more menu commands from the parent window and each of the one or more menu commands from the one or more child windows to a corresponding menu command id and associating each of the corresponding menu command ids to a corresponding, section of code for executing an action such that a given menu command may be used in multiple command menus without having to program a given corresponding section of code more than once.

A MDI graphical user interface system, comprises a parent window, one or more command menus, corresponding to one or more parent window features, within the parent window, one status bar, corresponding to one or more parent window features, within the parent window, one or more child windows, one or more command menus, corresponding to one or more child window features, within each of the one or more child windows and one status bar, corresponding to one or more child window features, within each of the one or more child windows.

A MDI graphical user interface system, comprises designing a parent window, designing one or more command menus, each comprising one or more menu commands, for the parent window, within the parent window, designing one status bar for the parent window, within the parent window, designing one or more child windows within the parent window, designing one or more command menus, each comprising one or more menu commands, for each of the one or more child windows within the one or more child windows, designing one status bar, for each of the one or more child windows, within the one or more child windows; assigning each of the one or more menu commands from the parent window and each of the one or more menu commands from the one or more child windows to a corresponding menu command id and associating each of the corresponding menu command ids to a corresponding section of code for executing an action such that a given menu command may be used in multiple command menus without having to program a given corresponding section of code more than once.

A computer system comprises a processor and a computer recording medium including computer executable executable by the processor for displaying a MDI graphical user interface. The computer executable code comprises code for displaying a parent window, code for displaying one or more command menus, corresponding to one or more parent window features, within the parent window, code for displaying one status bar, corresponding to one or more parent window features, within the parent window, code for displaying one or more child windows, code for displaying one or more command menus, corresponding to one or more child window features, within each of the one or more child windows and code for displaying one status bar, corresponding to the one or more child window features, within each of the one or more child windows.

A computer system comprises a processor and a computer recording medium including (computer executable code executable by the processor for designing a MDI graphical user interface. The computer executable code comprises code for designing a parent window, code for designing one or more command menus, each comprising one or more menu commands, for the parent window, within the parent window, code for designing one status bar for the parent window, within the parent window, code for designing one or more child windows within the parent window, code for designing one or more command menus, each comprising one or more menu commands, for each of the one or more child windows within the one or more child windows, code for designing one status bar, for each of the one or more child windows within the one or more child windows, code for assigning each of the one or more menu commands from the parent window and each of the one or more menu commands from the one or more child windows to a corresponding menu command id and code for associating each of the corresponding menu command ids to a corresponding section of code for executing an action such that a given menu command may be used in multiple command menus without having to program a given corresponding section of code more than once.

A computer recording medium includes computer executable for displaying a MDI graphical user interface. The computer executable code comprises code for displaying a parent window, code for displaying one or more command menus, corresponding to one or more parent window features, within the parent window, code for displaying a status bar corresponding to one or more parent window features, within the parent window, code for displaying one or more child windows, code for displaying one or more command menus, corresponding to one or more child window features, within each of the one or more child windows and code for displaying one status bar, corresponding to one or more child window features, within each of the one or more child windows.

A computer recording medium includes computer executable code for designing a MDI graphical user interface. The computer executable code comprises code for designing a parent window, code for designing one or more command menus, each comprising one or more menu commands, for the parent window, within the parent window code for designing one status bar for the parent window, within the parent window, code for designing one or more child windows within the parent window, code for designing, one or more command menus, each comprising one or more menu commands, for each of the one or more child windows within the one or more child windows, code for designing one status bar for each of the one or more child windows within the one or more child windows, code for assigning each of the one or more menu commands from the parent window and each of the one or more menu commands from the one or more child windows to a corresponding menu command id and code for associating each of the corresponding menu command ids to a corresponding section of code for executing an action such that a given menu command may be used in multiple command menus without having to program a given corresponding section of code more than once.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. is an example of a MDI graphical user interface;

FIG. 2 is an example of a MDI graphical user interface according to an embodiment of the present disclosure;

FIG. 3 is a flow chart illustrating a method for displaying a MDI graphical user interface according to an embodiment of the present disclosure;

FIG. 4 is a flow chart illustrating a method for designing a MDI graphical user interface according to an embodiment of the present disclosure; and

FIG. 5 shows an example of a computer system capable of implementing the method and apparatus according to embodiments of the present disclosure.

### DETAILED DESCRIPTION

In describing the preferred embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

MDI refers to a graphic user interface (GUI) in which a backing window, a single primary parent window, may be represented as a graphical object within a desktop space. The parent window may contain a set of documents and/or applications appearing within one or more child windows. Each child window may appear within the parent window instead of on the desktop. The parent window may display menus, a status bar, and toolbars.

Embodiments of the present disclosure may utilize the Java platform and may, for example, instantiate the parent window as a Java application or applet. Embodiments of the present disclosure may also utilize any other platform, for example Windows NT and the iSeries 400 environment.

When there are no child windows opened, the parent window may display its own menus, status bar and toolbars. These menu bar, toolbars and status bar may control features that relate primarily to the parent window. For example, the menu bar, toolbars and status bar of the parent window may allow for adjusting the way child windows are displayed. For example, the parent window may have a “window” menu or toolbar that allows the user to have child windows displayed in “cascade” style, where child windows overlap or in “tile” style, where child windows appear side-by-side.

Where there is more than one child window opened within the parent window, one of the child windows may be active. An active child window may be the child window that the user is presently interacting with. The user may select which child window is active. For example, the user may locate a cursor over the child window to activate it.

Menu bar and toolbars may present one or more selectable menu commands to the user. Toolbar commands are always linked to corresponding menu commands. The programming of the MDI may assign each menu command a menu command id. The menu command id may alternatively be referred to as an event id. Each menu command id may then be associated with an action diagram. The action diagram may be a section of code that represents the action that should be performed in the event that the user selects the associated menu command. A menu command map may be used to record association between menu command ids and action diagrams. The menu command map may alternatively be referred to as a property sheet. For example, a toolbar may include an “insert picture” toolbar button. The “insert picture” toolbar button may be assigned a menu command id of “16.” The menu command map may be a table that associates menu command id 16 with an action diagram for inserting a picture into a document. The action diagram may then contain code for effecting the insertion of a picture into a document. Then at runtime, when the user selects the “insert picture” toolbar button, a picture will be inserted into a document. This menu command id of “16” can be invoked by the parent window or by any child window without the need of duplicating code.

An action diagram may optionally be associated directly to a menu command, for example a menu command appearing in a child window. This may be in addition to associating a menu command id to the menu command. In such a case, when the menu command is selected at runtime, the directly associated action diagram may be executed after the action diagram associated with the associated menu command id is executed. This may be used to trigger the execution of the parent's action diagram first, followed by the execution of the child's action diagram.

According to an embodiment of the present disclosure, each opened child window may have its own menu bar, toolbars and status bar displayed within the respective child window. These menus and toolbars may then feature one or more menu commands that may relate to the corresponding child window. One or more menu commands relating to the parent window may optionally appear within the child window's menus and toolbars in addition to the menu commands relating to the child window.

The parent window may then have its own menus, status bar, and toolbars within its window. These menus and toolbars may then feature one or more menu commands that may relate to the parent window. One or more menu commands relating to a child window, for example the active child window, may optionally appear within the parent window's menus, and toolbars in addition to the menu commands relating to the parent window.

According to another embodiment of the present disclosure, menu commands used with respect to one window may be used by another window without having to program the same menu command multiple times for multiple windows. This feature may alleviate the need to repeat lines of code. Menu commands may therefore be shared between windows. For example, a parent window and a child window may share one or more menu commands. For example, two child windows may share one or more menu commands.

This feature may be particularly desirable where the same menu command is to appeal in multiple different windows. For example, the “save” command is a menu command that may be used in a large number of windows.

Shared menu commands may utilize a single menu command id. For example, a menu command for one window may be assigned the same menu command id as a menu command for another window. That menu command id may then be mapped to a single action diagram. At runtime, it may be possible for a menu command associated with one window and a menu command associated with another window to produce the same action upon selection without having to program the same action twice.

Menu commands may also be shared between parent and child windows

Embodiments of the present disclosure may utilize either or both of the above-disclosed features. For example, one embodiment of the present disclosure may utilize a set of menus, status bar, and toolbars in the parent window and a set of menus, status bar, and toolbars in each child window. For example, another embodiment of the present disclosure may utilize shared menu command ids among multiple windows. For example another embodiment of the present disclosure may utilize a set of menus, status bar, and toolbars in the parent window and a set of menus, status bar, and toolbars in each child window and may utilize shared menu command ids among multiple windows.

Embodiments of the present disclosure may also allow the user to determine whether to utilize the above disclosed features. For example, a user may choose to utilize the more traditional MDI behavior where the menus, status bar, and toolbars relating to the active child window appear only in the parent window. The user may be able to select this option. The user may choose to utilize a set of menus, status bar, and toolbars in the parent window and a set of menus, status bar, and toolbars in each child window. The user may be able to select this option as well.

When a MDI child window is designed, it may not be necessary to specify the MDI parent to which it belongs. This information may be derived from calls between the associated functions of the parent and/or child windows. When a function that scopes functions of a child window is called by a function that scopes a parent panel, the child window may automatically display within the parent window.

Embodiments of the present disclosure may be implemented, for example, as the GUI of computer applications. Additionally, embodiments of the present disclosure may be implemented, for example, within computer applications for generating GUs, such as, for example, AllFusion Plex™ offered by Computer Associates.

FIG. 1 is an example of a traditional MDI graphical user interface. Within the MDI graphical user interface 10 there is a parent window 11 and a single child window 12 located within the parent window. The parent window includes a menu, toolbar and status bar 13. This menu, toolbar and status bar 13 relate to functionality of the active child window 12. The child window 12 does not have its own menu, toolbar and status bar. The parent window's 11 menu, toolbar and status bar are not accessible and may only be accessible when all child windows 12 are closed and only the parent window 11 remains open.

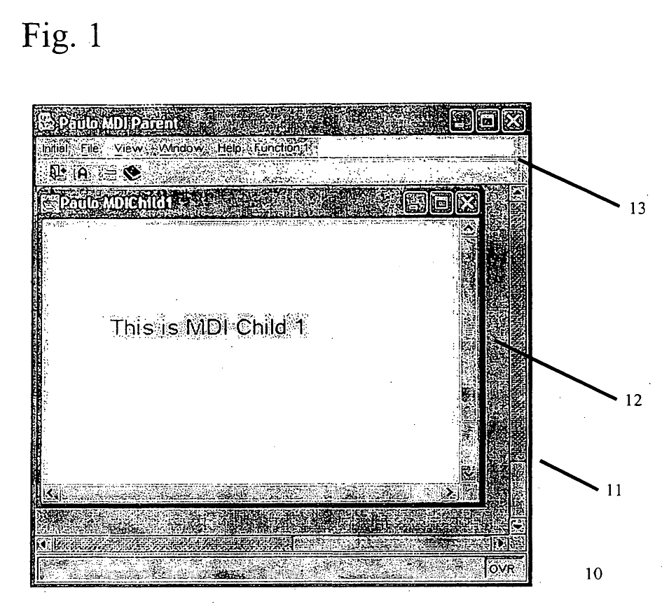

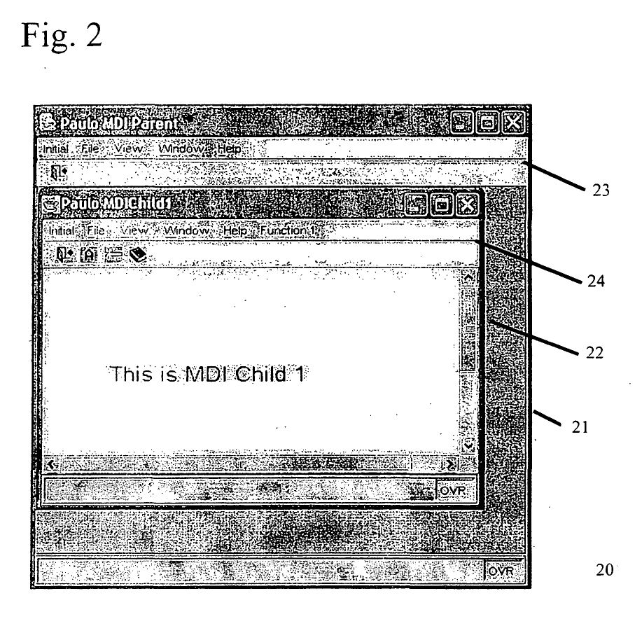

FIG. 2 is an example of a MDI graphical user interface according to an embodiment of the present disclosure. Within the MDI graphical user interface 20, there is a parent window 21 and a child window 22. The parent window 21 has a menu, toolbar and status bar 23 that corresponds to parent window 21 functionality. The child window 22 also has a menu, toolbar and status bar 24 that corresponds to child window 22 functionality. Both the parent menu, toolbar and status bar 23 and the child menu, toolbar and status bar 24 may be accessible at any given time.

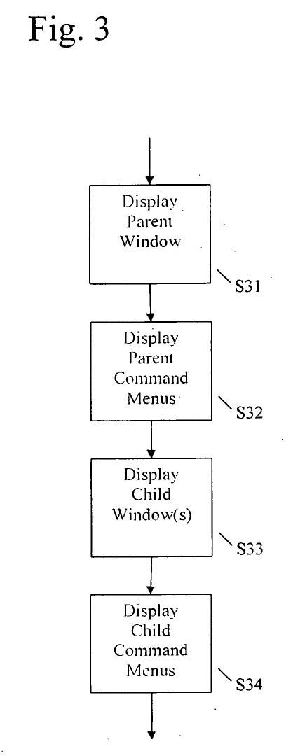

FIG. 3 is a flow chart illustrating a method for displaying a MDI graphical user interface according to an embodiment of the present disclosure. A parent window may be displayed (Step S31). One or more menus, toolbars and status bar (command menus) corresponding to one or more parent window features may be displayed within the parent window (Step S32). One or more child windows may be displayed within the parent window (Step S33). One or more menus, toolbars and status bar corresponding to each of the one or more child windows corresponding to one or more child window features may be displayed within each child window (Step S34).

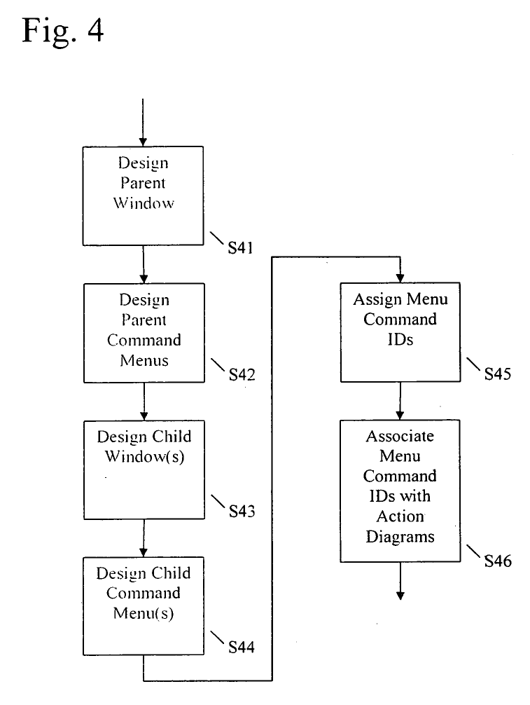

FIG. 4 is a flow chart illustrating a method for designing a MDI graphical user interface according to an embodiment of the present disclosure. A parent window may be designed (Step S41). One or more menus, toolbars and status bar, comprising one or more menu commands, corresponding to one or more parent window features may be designed (Step S42). One or more child windows may be designed (Step S43). One or more menus, toolbars and status bar, comprising one or more menu commands, corresponding to each of the one or more parent window features may be designed (Step S44). Each of the menu commands from the parent window and the one or more child windows may be assigned a menu command id (Step S45). Each menu command id may be associated with an action diagram (Step S46). Each menu command id may be included any number of menus, toolbars and status bar of the child windows and parent window. The same menu commands may then appear within multiple windows, for example, within a parent window and a child window, without having to program the same action diagram more than once.

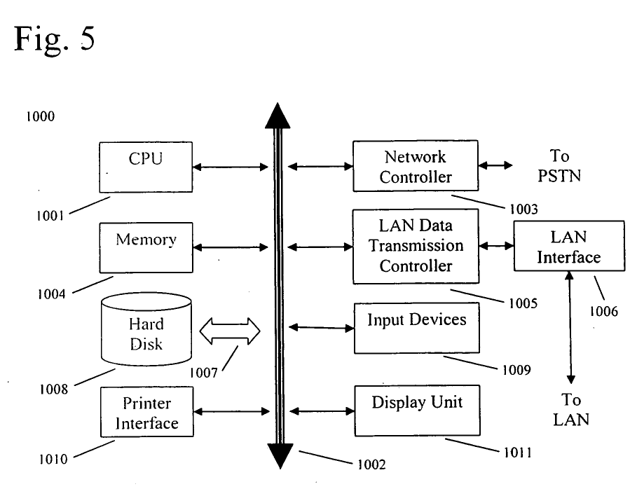

FIG. 5 shows an example of a computer system which may implement the method and system of the present disclosure. The system and method of the present disclosure may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

The computer system referred to generally as system 1000 may include, for example, a central processing unit (CPU) 1001, random access memory (RAM) 1004, a printer interface 1010, a display unit 1011, a local area network (LAN) data transmission controller 1005. a LAN interface 1006, a network controller 1003, an internal bus 1002, and one or more input devices 1009, for example, a keyboard, mouse etc. As shown, the system 1000 may be connected to a data storage device, for example, a hard disk, 1008 via a link 1007.

The above specific embodiments are illustrative, and many variations can be introduced on these embodiments without departing from the spirit of the disclosure or from the scope of the appended claims. For example, elements and/or features of different illustrative embodiments may be combined with each other and/or substituted for each other within the scope of this disclosure and appended claims.

1. A method for displaying a MDI graphical user interface, comprising:
displaying a parent window;
displaying one or more command menus, corresponding to one or more parent window features, within the parent window;
displaying one status bar, corresponding to one or more parent window features, within the parent window;
displaying one or more child windows;
displaying one or more command menus, corresponding to one or more child window features, within each of the one or more child windows; and
displaying one status bar, corresponding to one or more child window features, within each of the one or more child windows.

2. The method of claim 1, wherein one or more of the command menus are pull-down menus.

3. The method of claim 1, wherein one or more of the command menus are toolbar buttons.

4. The method of claim 1, wherein the parent window is displayed on top of an operating system desktop.

5. The method of claim 1, wherein:
each of the one or more command menus from the parent window and each of the one or more command menus from the one or more child windows comprises one or more menu commands corresponding to executable actions;
each of the menu commands corresponds to a menu command id; and
each of the corresponding menu command ids corresponds to a corresponding section of code for executing the corresponding action such that a given menu command may be eased in multiple command menus without having to program a given corresponding section of code more than once.

6. A method for designing a MDI graphical user interface, comprising:
designing a parent window;
designing one or more command menus, each comprising one or more menu commands, for the parent window;
designing one status bar for the parent window;
designing one or more child windows within the parent window;
designing one or more command menus, each comprising one or more menu commands, for each of the one or more child windows within the one or more child windows;
designing one status bar for each of the one or more child windows within the one or more child windows;
assigning each of the one or more menu commands from the parent window and each of the one or more menu commands from the one or more child windows to a corresponding menu command id; and
associating each of the corresponding menu command ids to a corresponding section of code for executing an action such that a given menu command may be used in multiple command menus without having to program a given corresponding section of code more than once.

7. The method of claim 6, wherein one or more of the command menus are pull-down menus.

8. The method of claim 6, wherein one or more of the command menus are toolbar buttons.

9. The method of claim 6, wherein the parent window is displayed on top of an operating system desktop.

10. A MDI graphical user interface system, comprising:
a parent window;
one or more command menus, corresponding to one or more parent window features,within the parent window;
one status bar, corresponding to one or more parent window features, within the parent window:
one or more child windows;
one or more command menus, corresponding to one or more child window features, within each of the one or more child windows; and
one status bar, corresponding to one or more child window features, within each of the one or more child windows.

11. The system of claim 10, wherein one or more of the command menus are pull-down menus.

12. The system of claim 10, wherein one or more of the command menus are toolbar buttons.

13. The system of claim 10, wherein the parent window is displayed on top of an operating system desktop.

14. The system of claim 10, wherein:
each of the one or more command menus from the parent window and each of the one or more command menus from the one or more child windows comprises one or more menu commands corresponding to executable actions;
each of the menu commands corresponds to a menu command id; and
each of the corresponding menu command ids corresponds to a corresponding section of code for executing the corresponding action such that a given menu command may be used in multiple command menus without having to program a given corresponding section of code more than once.

15. A MDI graphical user interface system, comprising:
designing a parent window;
designing one or more command menus, each comprising one or more menu commands, for the parent window, within the parent window;
designing one status bar for the parent window, within the parent window;
designing one or more child windows within the parent window;
designing one or more command menus, each comprising one or more menu commands, for each of the one or more child windows within the one or more child windows:
designing one status bar, for each of the one or more child windows, within the one or more child windows;
assigning each of the one or more menu commands from the parent window and each of the one or more menu commands from the one or more child windows to a corresponding menu command id; and
associating each of the corresponding menu command ids to a corresponding section of code for executing an action such that a given menu command may be used in multiple command menus without having to program a given corresponding section of code more than once.

16. The system of claim 15, wherein one or more of the command menus are pull-down menus

17. The system of claim 15, wherein one or more of the command menus are toolbar buttons.

18. The system of claim 15, wherein the parent window is displayed on top of an operating system desktop.

19. A computer system comprising:
a processor; and
a computer recording medium including computer executable executable by the processor for displaying a MDI graphical user interface, the computer executable code comprising:
code for displaying a parent window;
code for displaying one or more command menus, corresponding to one or more parent window, features, within the parent window;
code for displaying one status bar, corresponding to one or more parent window features, within the parent window;
code for displaying one or more child windows;
code for displaying one or more command menus, corresponding to one or more child window features, within each of the one or more child windows; and
code for displaying one status bar, corresponding to the one or more child window features, within each of the one or more child windows.

20. The computer system of claim 19, wherein one or more of the command menus are pull-down menus.

21. The computer system of claim 19, wherein one or more of the command menus are toolbars.

22. The computer system of claim 19, wherein the parent window is displayed on top of an operating system desktop.

23. The computer system of claim 19, wherein:
each of the one or more command menus from the parent window and each of the one or more command menus from the one or more child windows comprises one or more menu commands corresponding to executable actions;
each of the menu commands corresponds to a menu command id; and
each of the corresponding menu command ids corresponds to a corresponding section of code for executing the corresponding action such that a given menu command may be used in multiple command menus without having to program a given corresponding, section of code more than once.

24. A computer system comprising:
a processor; and
a computer recording medium including computer executable code executable by the processor for designing a MDI graphical user interface, the computer executable code comprising:
code for designing a parent window;
code for designing one or more command menus, each comprising one or more menu commands, for the parent window, within the parent window;
code for designing one status bar for the parent window, within the parent window;
code for designing one or more child windows within the parent window;
code for designing one or more command menus, each comprising one or more menu commands, for each of the one or more child windows within the one or more child windows;
code for designing one status bar, for each of the one or more child windows within the one or more child windows;
code for assigning each of the one or more menu commands from the parent window and each of the one or more menu commands from the one or more child windows to a corresponding menu command id; and
code for associating each of the corresponding menu command ids to a corresponding section of code for executing an action such that a given menu command may be used in multiple command menus without having to program a given corresponding section of code more than once.

25. The computer system of claim 24, wherein one or more of the command menus are pull-down menus.

26. The computer system of claim 24, wherein one or more of the command menus are toolbar buttons.

27. The computer system of claim 24, wherein the parent window is displayed on top of an operating system desktop.

28. A computer recording medium including computer executable for displaying a MDI graphical user interface, the computer executable code comprising:
code for displaying a parent window;
code for displaying one or more command menus, corresponding to one or more parent window features, within the parent window;
code for displaying a status bar corresponding to one or more parent window features, within the parent window;
code for displaying one or more child windows;
code for displaying one or more command menus, corresponding to one or more child window features, within each of the one or more child windows; and
code for displaying one status bar, corresponding to one or more child window features, within each of the one or more child windows.

29. A computer recording medium including computer executable code for designing a MDI graphical user interface, the computer executable code comprising:
code for designing a parent window;
code for designing one or more command menus, each comprising one or more menu commands, for the parent window, within the parent window;
code for designing one status bar for the parent window, within the parent window;
code for designing one or more child windows within the parent window;
code for designing one or more command menus, each comprising one or more menu commands, for each of the one or more child windows within the one or more child windows:
code for designing one status bar for each of the one or more child windows within the one or more child windows;
code for assigning each of the one or more menu commands from the parent window and each of the one or more menu commands from the one or more child windows to a corresponding menu command id; and
code for associating each of the corresponding menu command ids to a corresponding section of code for executing an action such that a given menu command may be used in multiple command menus without having to program a given corresponding section of code more than once.
